(19) United States
(12) Patent Application Publication
(10) Pub. No.: US 2011/0130897 A1
(43) Pub. Date: Jun. 2, 2011

(54) ADVANCED PRIMARY NAVIGATION DISPLAYS FOR PRECISION AND NON-PRECISION APPROACHES

(75) Inventors: Gary Stephen Gladysz, JR., Maricopa, AZ (US); Shawn Mitchell Hyde, Grandview Heights, OH (US)

(73) Assignee: L-3 COMMUNICATIONS AVIONICS SYSTEMS, INC., Grand Rapids, MI (US)

(21) Appl. No.: 13/055,946

(22) PCT Filed: Jul. 30, 2009
(86) PCT No.: PCT/US09/52246

§ 371 Date: Jan. 26, 2011

Related U.S. Application Data
(60) Provisional application No. 61/084,896, filed on Jul. 30, 2008.

(51) Int. Cl. B64D 45/04; G08G 5/00; G01C 21/00; G01S 7/04

(52) U.S. Cl. 701/15

(57) ABSTRACT

A flight display system provides advanced, or previewed, indications of the aircraft's position relative to an approach via a primary flight display. The primary flight display displays one or both of horizontal and vertical deviation indicators with respect to the aircraft's current position prior to the aircraft reaching the final approach. A feature of the horizontal and vertical deviation indicators may change on the primary flight display when the aircraft reaches the final approach, such as their color. The display system may also include an approach annunciator that provides an indication of the type of approach and the navigation source for the approach. The approach annunciator is displayed prior to the final approach becoming the active leg of the flight plan. The previewed information may appear automatically on the primary flight display based upon a distance of the aircraft to the airport or runway.

### CROSS-REFERENCE TO RELATED APPLICATIONS

This application claims priority to U.S. provisional patent application Ser. No. 61/084,896, filed Jul. 30, 2008 by applicant Gary Gladysz, Jr., entitled “Advanced Primary Navigation Displays for Precision and Non-Precision Approaches,” the complete disclosure of which is hereby incorporated herein by reference.

### BACKGROUND OF THE INVENTION

The present invention relates to cockpit displays for aircraft, and more particularly to a system and method for displaying information relating to the landing of an aircraft.

Prior aircraft instrumentation systems have displayed precision approach deviation indicators (PADI) while an aircraft is on the final approach to a runway. These PADI include both horizontal and vertical indicators that indicate to the pilot the degree of horizontal and vertical deviation of the aircraft from the final approach.

### SUMMARY OF THE INVENTION

The present invention relates to an improved system and method for displaying approach deviation indicators on a display of an aircraft, such as, but not necessarily, the primary flight display (PFD).

According to various embodiments, a primary flight display (PFD) is provided that provides advanced indication of an aircraft's lateral and/or vertical deviation from an approach vector prior to the aircraft reaching the approach vector. The approach vector may be a final approach vector, an initial approach vector, or an intermediate approach vector. In addition to displaying the lateral and/or vertical deviation, the PFD may display an approach annunciator that provides an indication of the type of approach and the navigation source for the approach, the latter of which may be different from the current navigation source being used by the aircraft. The pilot is therefore given an advanced indication of the craft's deviation from the approach vector prior to arriving at the approach vector, thereby giving the pilot better situational awareness.

According to one embodiment, an aircraft cockpit display system is provided. The aircraft cockpit display system includes a primary flight display (PFD), a navigation system, a memory, and a controller. The navigation system is adapted to determine a current position and heading of the aircraft. The memory is adapted to store information relating to a final approach leg and a pre-final approach leg of an aircraft flight plan. The controller communicates with the navigation system and the memory. The controller causes the PFD to display a horizontal situation indicator (HSI) at a first location on the PFD and horizontal deviation indicators at a second location on the PFD. The horizontal deviation indicators provide an indication of the aircraft's current position with respect to the final approach both when the pre-final approach leg is an active leg of the aircraft flight plan and when the final approach leg is an active leg of the aircraft flight plan.

According to another embodiment, an aircraft cockpit display system is provided that includes a primary flight display (PFD), a navigation system, a memory, and a controller. The navigation system determines a current position and heading of the aircraft. The memory stores information relating to an approach vector for a runway. The controller communicates with the navigation system and the memory. The controller causes the PFD to display horizontal deviation indicators indicating a horizontal or lateral deviation of the aircraft's current position from the approach vector prior to the aircraft capturing the approach vector. The display of the horizontal deviation indicators is done automatically by the controller without requiring a pilot to manipulate any controls on the PFD.

According to another aspect, a method of displaying information on a primary flight display is provided. The method includes determining when a flight plan leg preceding a final approach leg is an active leg of an aircraft flight plan. Further, the method includes displaying in a first location on the PFD a horizontal situation indicator (HSI) indicating a deviation of the aircraft's position with respect to the flight plan leg that precedes the final approach leg. The method further includes displaying in a second location on the PFD either horizontal or vertical deviation indicators, or both, while the flight plan leg preceding the final approach leg is the active leg. The horizontal and/or vertical deviation indicators indicate the aircraft's current horizontal and vertical deviations from the final approach leg, respectively.

According to yet another aspect, a method of displaying information on a primary flight display (PFD) of an aircraft cockpit is provided. The method includes determining a current position of an aircraft and automatically displaying, without requiring a pilot to manipulate any controls on the PFD, at least a horizontal deviation indicator from a final approach prior to the final approach becoming an active segment of a flight plan for the aircraft.

According to still another aspect, an aircraft cockpit display system is provided that includes a primary flight display (PFD), a navigation system, a memory, and a controller. The navigation system determines a current position and heading of the aircraft. The memory stores information relating to an approach for a runway, and the controller is in communication with the navigation system and the memory. The controller further causes the PFD to automatically display an approach annunciator indicating a type of the approach and a navigation source for the approach. This automatic display is done prior to the final approach becoming an active leg of the flightplan and without requiring any pilot manipulation of any controls of the PFD.

According to other aspects, the PFD may display the horizontal deviation indicators on a portion of the display separate from a horizontal situation indicator (HSI). The display of the horizontal and/or vertical deviation indicators may change when the aircraft has traveled from the pre-final approach leg to the final approach. Such a change may involve a change in the color of the deviation indicators. An autopilot system may be used to determine whether the aircraft has captured a particular flight vector. An approach annunciator may be displayed on the PFD prior to the final leg becoming an active leg wherein the approach annunciator indicates both a type of approach to the runway and a navigation source to be used for the approach to the runway. A current source of navigation may also be displayed on the PFD which may be different from the navigation source displayed in the approach annunciator. The system may also automatically display the deviation indicators (horizontal and/or vertical) based upon the aircraft being within a predetermined range of the runway or the corresponding airport for the runway.

The various embodiments of the present invention provide advance information to the pilot regarding the aircraft's deviation from the final approach prior to the aircraft arriving at the final approach. This advance information assists the pilot in guiding and landing the aircraft.

### BRIEF DESCRIPTION OF THE DRAWINGS

FIG. 1 is a perspective view of an exemplary aircraft cockpit illustrating one possible layout of an avionic flight control and display system that may incorporate aspects of the present invention;

FIG. 2 is a block diagram of the components of an aircraft cockpit display system according to one embodiment;

FIG. 3 is an illustrative screen shot of a multi-function display (MFD) that includes a map view of a flight plan and textual information regarding a flight plan, along with a manner for selecting an LPV approach from a menu;

FIG. 4 is an illustrative screen shot of the multi-function display of FIG. 3 showing a manner for activating a vector to final (VTF) procedure;

FIG. 5A is an illustrative screen shot of several items that may be displayed on a primary flight display (PFD) prior to the aircraft reaching a final approach segment;

FIG. 5B is an illustrative screen shot of the MFD illustrating the aircraft's position at substantially the same moment in time as the screenshot of FIG. 5A;

FIG. 6A is an illustrative screen shot of a primary flight display (PFD) showing vertical and horizontal deviations for a final approach segment prior to the aircraft reaching the final approach segment;

FIG. 6B is an illustrative screen shot of the MFD illustrating flight plan information and aircraft position corresponding substantially to the moment in time of FIG. 6A;

FIG. 7 is an elevational view of an illustrative design of a deviation indicator that may be displayed on the primary flight display;

FIG. 8 is an elevational view of an illustrative design of an approach annunciator that may be displayed on the primary flight display;

FIG. 9A is an illustrative screen shot of a primary flight display showing horizontal and vertical deviation indicators during one example of an instrument landing system (ILS) approach with a course reversal procedure turn; and

FIG. 9B is an illustrative screen shot of a multi-function display showing the location of the aircraft on a map at substantially the moment in time corresponding to FIG. 9A.

### DETAILED DESCRIPTION OF THE EMBODIMENTS

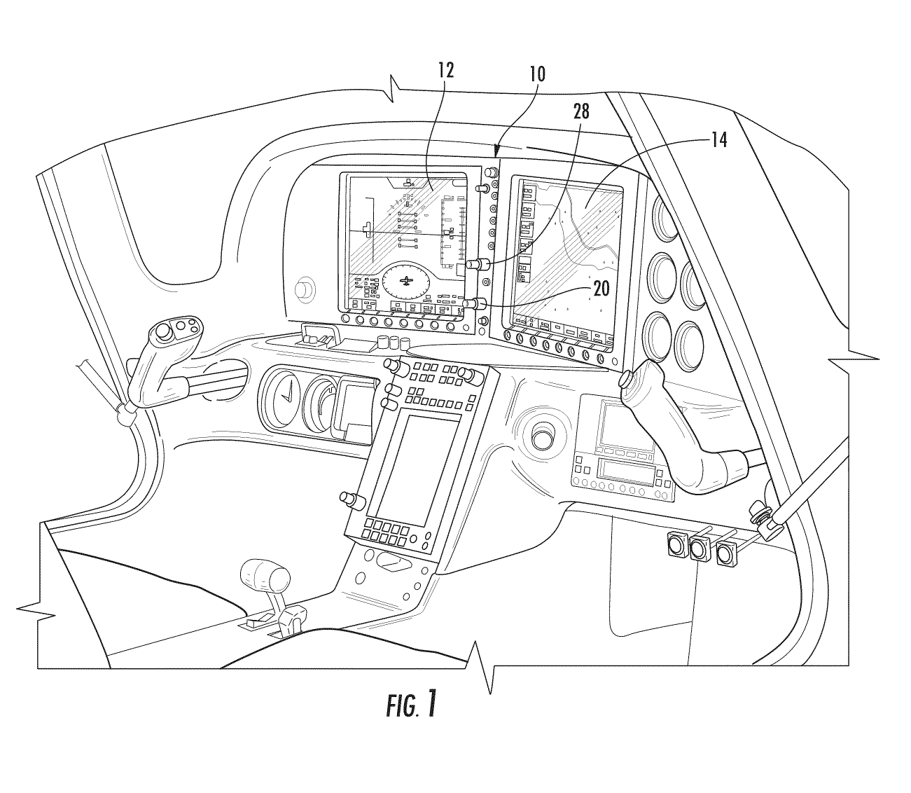

A cockpit flight display system 10 that may incorporate one or more features of the present invention is depicted in FIG. 1. Flight control and display system 10 includes a primary flight display (PFD) 12 and a multi-function display (MFD) 14, both of which are positioned within a cockpit of a conventional aircraft. It will be understood by those skilled in the art that flight display system 10 may omit multi-function display 14 in various embodiments, or it may include additional multi-function displays 14 and/or additional primary flight displays 12.

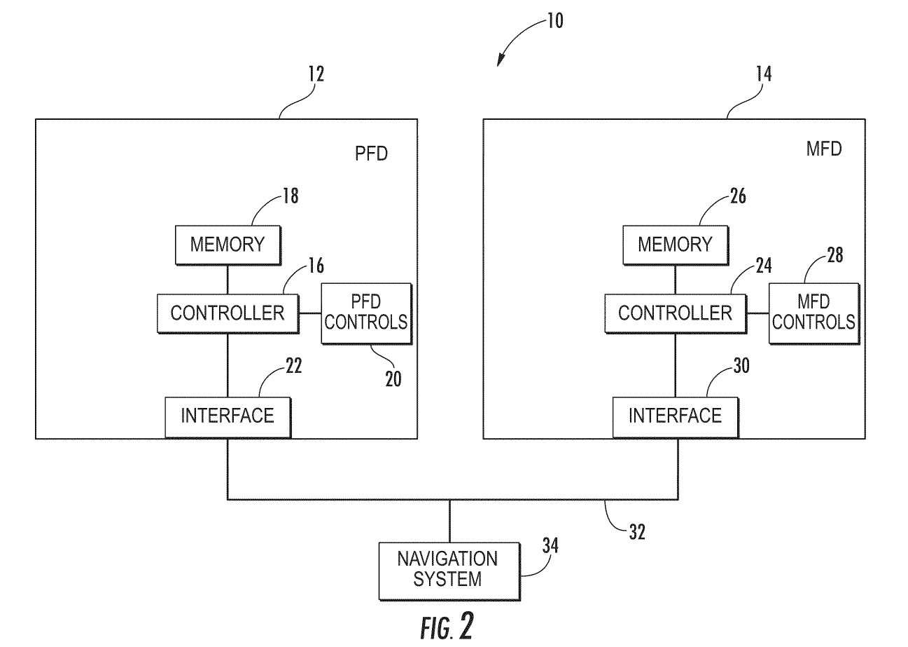

As is illustrated in more detail in FIG. 2, primary flight display 12 includes at least one controller 16, a memory 18, at least one control 20, and an interface 22. Multi-function display 14 also includes at least one controller 24, a memory 26, at least one control 28, and an interface 30. PFD 12 and MFD 14 may be in communication with each other over a communications bus 32, which may be any suitable communication bus for communicating electronic information within an aircraft. In one embodiment, communication bus 32 may be a conventional IEEE (Institute of Electrical and Electronic Engineers) 1394 LAN (Local Area Network). Other types of networks and/or communication media may be used.

Controllers 16 and 24 may each be any type of conventional or non-conventional electronic device capable of carrying out the control functions described herein. In one embodiment, each controller 16 and 24 may be a conventional processor or microprocessor programmed to carry out the algorithms described herein, as well as other algorithms conventionally undertaken by conventional primary flight display and multi-function displays. In other embodiments, each controller 16 and 24 may comprise multiple processors or microprocessors working together to carry out the functions described herein. Still further, in some embodiments, the algorithms discussed herein may be carried out by one or more processors that are positioned in a location physically separate from the chassis housing either or both of the PFD 12 and MFD 14.

Regardless of the specific implementation of controllers 16 and 24, each one is configured to be able to dictate what information is displayed on the screen of PFD 12 and MFD 14, respectively. In dictating what is displayed on these screens, controllers 16 and 24 may each be in communication with, or include, one or more graphics processors, or other devices, that carry out the low-level instructions for controlling the graphics displayed on the screens of PFD 12 and MFD 14.

Memories 18 and 26 may each comprise one or more different types of electronic memory, such as RAM, flash memory, hard drives, and/or other known memory types. Memory 18 stores the instructions that are followed by controller 16 in carrying out the algorithms described below and that are used to control the display of information on PFD 12. Memory 26 stores the instructions that are followed by controller 24 in carrying out the display functions of the MFD. Either one or both of these memories 16 and 24, or another memory not shown, may store flight path data and/or navigation information that is used by processor or controller 16 in carrying out the algorithms described below.

The controls 20 and 28 of PFD 12 and MFD 14 may take on a variety of different physical implementations. Such physical implementations may include one or more push-buttons, knobs, soft keys, hard-keys, line-select keys, or other devices that allow the pilot to input information into PFD 12 and/or MFD 14, and/or to direct or instruct these displays to perform certain actions. Interfaces 22 and 30 may comprise any suitable electronic structures that are able to translate messages into and out of the communications protocol used on communications bus 32 and into the format used by controllers 16 and 26. Interfaces 22 and 30 also may provide whatever other processing is necessary or desirable for handling the communications traffic flowing over communications bus 32.

Display system 10 is in communication with a navigation system 34. Navigation system may comprise one or more conventional navigation sensors used to determine information about the current position and heading of the aircraft. Such sensors may include one or more of the following: gyroscopes, accelerometers, global positioning system (GPS) sensors, air data sensors, magnetometers, distance measuring equipment (DME), navigation radios (VOR/ILS) and other types of position and/or heading sensing equipment. The gyroscopes, accelerometers and air data units may be arranged in one or more conventional Air Data And Heading Reference Systems (ADAHRS), as are known in the avionics field. Whatever the particular arrangements and components of navigation system 34, navigation system 34 is adapted to provide information to controllers 16 and 24 about the current heading and position of the aircraft.

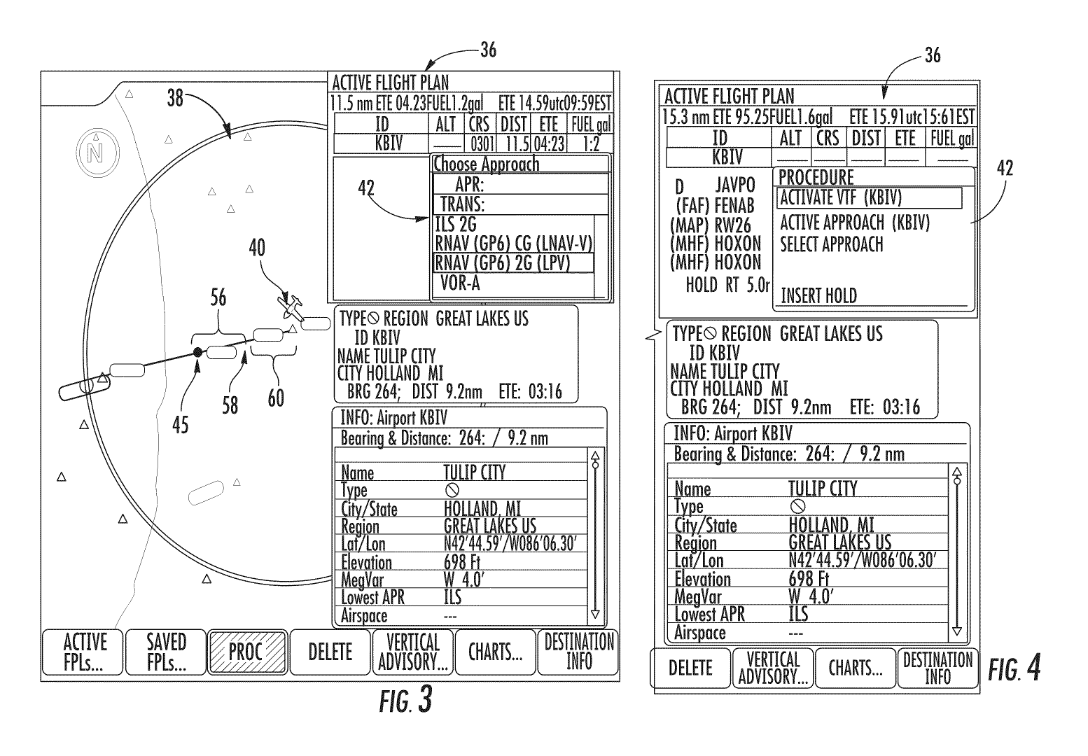

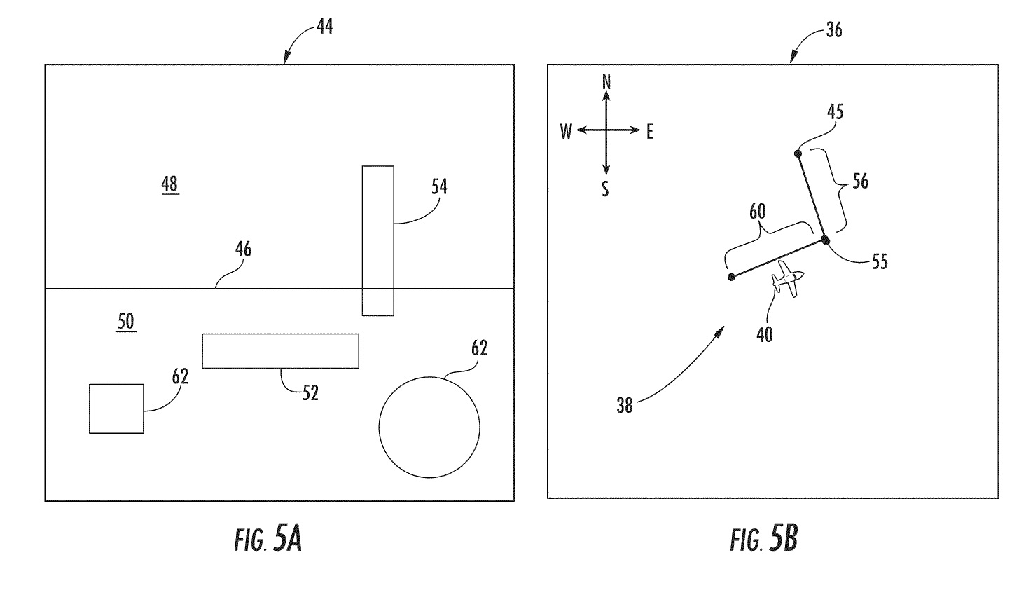

Display system 10 is set up, in the illustrated embodiments, to allow a pilot to enter a flight plan, or portions of a flight plan, into MFD 14. In order to enter such a flight plan, the pilot manipulates one or more of the MFD controls 28 until the appropriate screen is displayed on MFD in which a pilot may enter flight plan data. An example of a screenshot 36 that may be displayed on MFD 14 to allow a pilot to input flight planning information is shown in FIG. 3. The layout, content, and method by which flight planning information is entered into the flight management system of the aircraft may be varied from that illustrated in FIGS. 3 and 4. Screen shot 36 includes at least one drop-down menu 42 that includes information about the active flight plan. As illustrated in FIG. 3, a map section 38 is shown that includes an aircraft icon 40 indicating the current position of the aircraft relative to the displayed map. It will be understood by those skilled in the art that the inputting of information regarding an approach for a flight plan can be done at any time, including while on the ground, and that the position of aircraft icon 40 in FIG. 3 is therefore merely illustrative, not limiting. In other words, FIG. 3 should not be interpreted to mean that selecting an approach must be done while an aircraft is in flight and following a pre-final flight path segment 60.

In the screen shot 36 of FIG. 3, drop down menu 42 provides the pilot with a selection of choices for choosing a type of approach for an airport 45. Four options are listed in screen shot 36 of FIG. 3: ILS 26, RNAV (GPS) 26 (LNAV+V), RNAV (GPS) 26 (LPV), and VOR-A. Of course, the options that are available will depend upon the particular airport 45 and runway that the pilot is interested in flying an approach to, as well as other factors. In the screen shots 36 of FIGS. 3-4, the selected airport 45 is the Tulip City airport in Holland, Mich., and bears the identification letters KBIV. The selected runway is runway 26. The selection of the KBIV airport, the RNAV (GPS) 26 (LPV) approach type, and runway 26 in the drawings is an arbitrary selection that has been done herein for purposes of providing an illustrative example. As would be understood by a person skilled in the art, a pilot would be free to choose an approach and runway for whatever airport was of interest and whose approach information was available in a memory or database accessible to controller 24 or controller 16.

FIG. 4 illustrates an illustrative screen shot showing one way in which a pilot can utilize MFD 14 to select a procedure. Drop-down menu 42 in FIG. 4 includes a selection for activating a vector-to-final (VTF) procedure for the KBIV airport, which has been highlighted. By manipulating a suitable control 28 for MFD 14, a pilot can select when to activate the vector-to-final procedure.

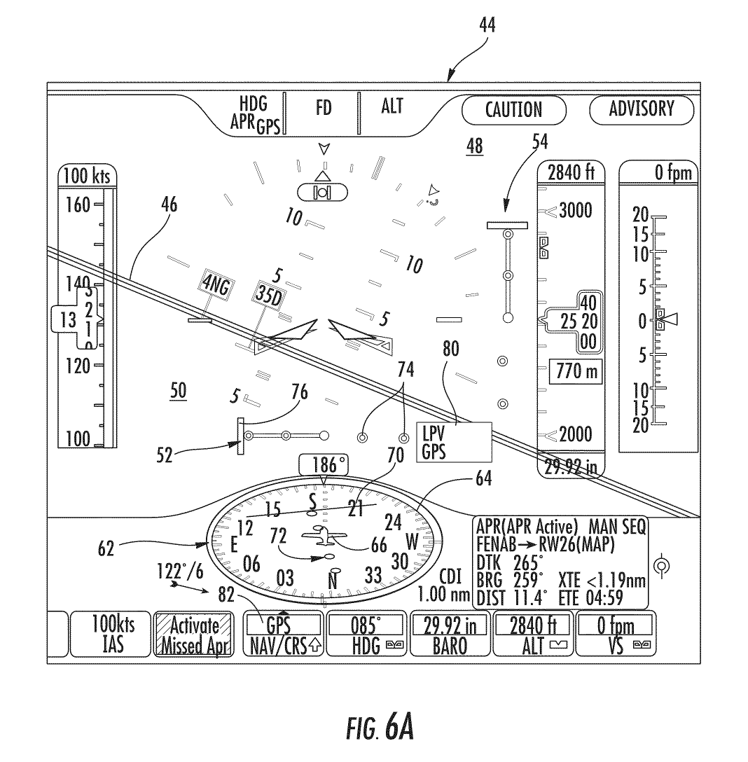

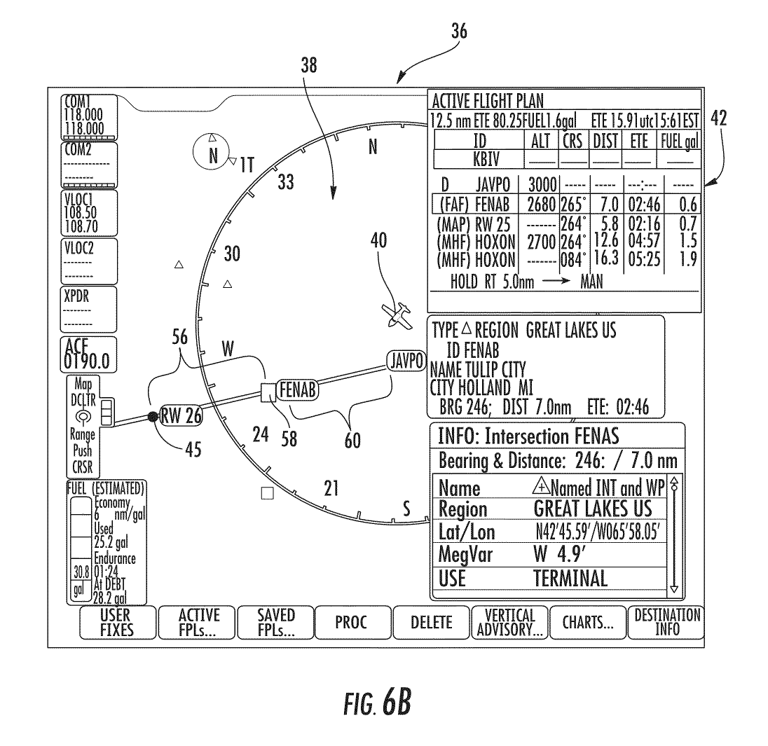

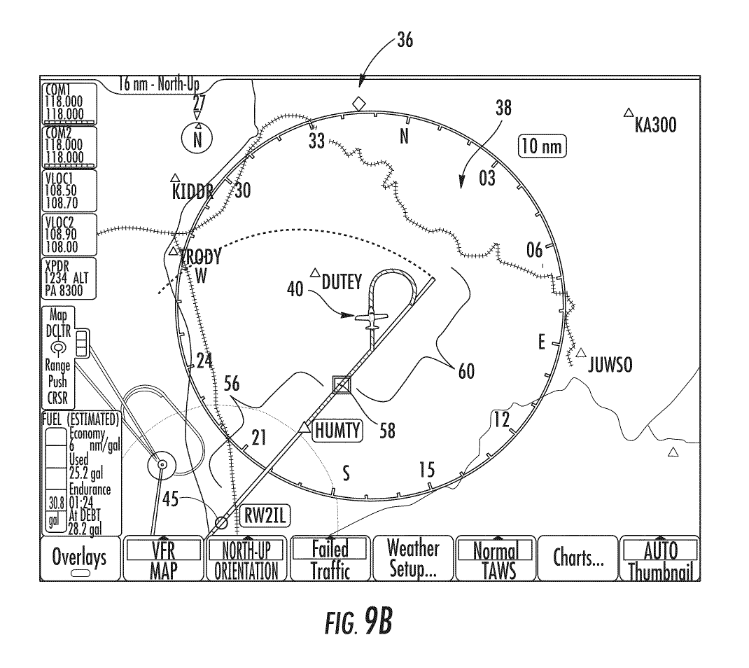

FIG. 5A illustrates an illustrative PFD screen shot 44 that may be displayed on PFD 12 at the same moment an aircraft is located at the position represented by aircraft icon 40 on map section 38 of the MFD screenshot 36 shown in FIG. 5B. That is, FIGS. 5A and 5B represent PFD and MFD screen shots at substantially the same moment in time. The content of both of these screenshots 36 and 44 will change dynamically as the aircraft flies, as would be understood by one skilled in the art. That is, the position of aircraft icon 40 on MFD 14 will change with respect to map section 38 as the aircraft moves in order to continually provide an accurate and up-to-date indication of the aircraft's location on map 38. Further, an artificial horizon line 46 displayed on PFD, that divides the screen into a sky portion 48 and a terrain portion 50, will continually change to represent the current flight roll and pitch conditions. The frequency at which the screens on PFD 12 and MFD 14 are changed in order to update the current flight conditions can be varied, but generally occurs multiple times a second. Additional information, such as, but not limited to, that shown on PFD screen shots of FIGS. 6A and 9A, may also be displayed on PFD 12. The following discussion, however, will focus on a horizontal deviation indicator 52, a vertical deviation indicator 54, an approach annunciator 80, and a horizontal situation indicator 62 displayed on PFD 12.

PFD screenshot 44 of FIG. 5A illustrates in diagram form both a horizontal deviation indicator 52 and a vertical deviation indicator 54. These indicators are often referred to as precision approach deviation indicators (PADI). These indicators provide an indication of the vertical and horizontal (or lateral) deviation of the aircraft's position relative to a final approach leg 56 of the flight plan. In the example illustrated in FIG. 5A, the horizontal and vertical deviation indicators 52 and 54 are both active. That is, they are each providing an indication of the aircraft's horizontal and vertical deviation, respectively, from final approach 56.

Flight display system 10 provides the feature of being capable of displaying the horizontal and vertical deviation indicators 52 and 54 on PFD 12 prior to the final approach segment 56 becoming the active segment of the flight plan. This can be seen, in one example, by comparing the position of the aircraft relative to its flight plan, as shown in FIG. 5B, with the horizontal and vertical deviation indicators 52 and 54 of FIG. 5A. As can be seen in FIG. 5B, the active leg of the aircraft's flight plan at the moment in time shown in FIG. 5B (which is the same as that in FIG. 5A) is a leg leading to a location 55. In the illustrated example, location 55 marks the beginning of the final approach segment 56. The current leg of the aircraft's flight plan in FIG. 5B is therefore the pre-final flight path segment or leg 60 that precedes the final approach to airport 45.

Keeping in mind the aircraft's current position, as represented by icon 40 in FIG. 5B, it can be seen that the horizontal and vertical deviation indicators 52 and 54 of PFD screenshot 44 are providing a preview, or an advanced view, of the aircraft's position with respect to the final approach segment 56 prior to the aircraft reaching the final approach segment. That is, in the screen shot of FIG. 5A, horizontal deviation indicator 52 provides an indication of the aircraft's current lateral position relative to final approach segment 56, not relative to the pre-final approach segment 60 that terminates at the waypoint 55. Similarly, in the screen shot of FIG. 5A, vertical deviation indicator 52 provides an indication of the aircraft's current vertical position relative to the final approach segment 56, not relative to the pre-final approach segment 60 that terminates at the waypoint 55. One illustrative manner in which indicators 52 and 54 may provide this information is shown in FIGS. 6A, 7 and 9A, as discussed more below.

Display system 10, in one embodiment, is configured to provide an indication to the pilot when horizontal and vertical deviation indicators 52 and 54 are providing previewed or advanced guidance (i.e. guidance information to the leg of the flight plan subsequent to the currently active leg), rather than guidance to the currently active flight plan segment. The manner in which this indication may be manifested can be varied. In one embodiment, the color of horizontal and vertical deviation indicators 52 and 54 may be a first color while previewed or advanced indications are provided, and a second color when indications to the currently active flight plan leg are provided. Such color variation may take on any suitable form. In but one example, horizontal and vertical deviation indicators 52 and 54 may be colored white at time periods when indications are being provided to the next flight path segment, and they may be colored green at time periods when indications are being provided to the currently active flight path segment. Other color combinations may also be used. Indeed, other types of annunciations may also be used to differentiate between advanced indications and current indications.

In addition to color changes alerting the pilot to which flight path segment the deviations of indicators 52 and 54 are being provided, display system 10 may be configured to provide indications to the pilot if and when the aircraft is out of range of the guidance signals used to provide horizontal and vertical deviation indications 52 and 54. Such out-of-range indications may involve yet another color change for indicators 52 and 54, or they may take on other forms, such as an “X” or series of stripes positioned over the indicator 52 or 54, or other forms (see, for example, indicator 54 of FIG. 9A).

As is also shown in FIG. 5A, PFD 12 displays a horizontal situation indicator (HSI) 62 that is positioned at any suitable location on the screen of PFD 12. HSI 62 provides an indication of the aircraft's current deviation from the currently active flight plan segment. One manner in which this indication may be provided is shown in FIGS. 6A and 9A, and discussed more below. When the aircraft is following the pre-final flight plan leg 60, HSI 62 will provide indications of horizontal deviations from leg 60 while horizontal deviation indicator 52 will provide indications of deviation from final approach leg 56. The pilot will therefore simultaneously see indications of horizontal deviation from the separate flight path legs, as well as, in some situations and embodiments, indications of vertical deviation, via indicator 54, from final approach segment 56.

FIGS. 6A and 6B provide a more detailed example of illustrative screen shots 44 and 36 that may appear on PFD 12 and MFD 14, respectively, as an aircraft nears an airport 45 for landing. Screen shot 44 of FIG. 6A shows an artificial horizon 46 and a roll scale that provides a current indication of the aircraft's roll. Artificial horizon 46 divides a large portion of the viewing area of screen shot 44 into a sky portion 48 and a terrain portion 50. Terrain portion 50 is rendered in FIG. 6A using what is referred to in the avionics industry as synthetic vision. That is, terrain portion 50 is rendered in such a manner so as to simulate the real-world terrain that would be visible to the pilot through the windshield of the aircraft at the aircraft's current location. It will be understood by those skilled in the art that PFD 12 could be modified to remove this synthetic vision capability, and instead simply display a uniform, or substantially uniform, color for the entire terrain portion 50. PFD 12 could also omit, or change the display of, the other information shown in FIG. 6A not directly relevant to the deviation indicators 52 and 54 and/or the approach annunciators 80, as will be described in more detail below. Further, PFD 12 could include additional information beyond that illustrated in FIG. 6A such as, but not limited to, Highway-in-the-Sky (HITS) information.

MFD screenshot 36 of FIG. 6B illustrates a more detailed example of a map section 38 and at least one drop-down menu 42. Drop down menu 42, in the example of FIG. 6B, indicates which of several flight plan segments is currently active. As shown, a flight plan segment leading to a location with the identifier FENAB is the currently active flight plan segment. This can be seen by drop-down menu 42 in FIG. 6B, which is labeled “Active Flight Plan,” and which has the flight plan leg to waypoint FENAB highlighted, thereby indicating that the leg leading to FENAB is the currently active leg of the flight plan. This currently active flight plan segment to waypoint FENAB is the pre-final segment 60 that precedes the final approach segment 56.

The horizontal and vertical deviation indicators 52 and 54 in FIG. 6A operate in the manner described above with respect to FIGS. 5A and 5B. That is, display system 10, via controller 16, will cause PFD 12 to automatically display horizontal and/or vertical deviation indicators 52 and/or 54 prior to final approach leg 56 becoming the active leg of the flight plan. This automatic display is carried out without requiring any action on the part of the pilot. That is, the pilot does not need to manipulate any controls on either PFD 12 or MFD 14, or any other instrument in the cockpit, in order to bring up the display of indicators 52 and/or 54. Instead, controller 16 will automatically cause these indicators to appear when the aircraft approaches within a specified range of a destination airport in a currently active flight plan. Further, it is not necessary for the pilot to tune any navigation radios for the indicators 52 and/or 54 to begin displaying accurate indications of horizontal and vertical deviation. Rather, controller 16 will retrieve from memory 18, or other accessible memory, stored information regarding the selected type of approach to airport 45 and automatically make any tuning adjustments that may be necessary in order for controller 16, or other suitable controller, to determine the aircraft's current deviation from the final approach segment 56. Still further, it is not necessary for the pilot to press any button or manipulate any control, such as a “preview” button or control, in order for deviation indicators 52 and 54 to appear and provide advanced indications of deviation relative to final approach 56. The deviations may be determined in a conventional manner, such as, by comparing the aircraft's current position, as determined by navigation system 34, with the final approach parameters.

When the active leg of the flight plan transitions from the pre-final leg 60 to the final approach leg 56, controller 16 will automatically provide an indication to the pilot of this transition. Such notification may involve a color change, as described above. That is, the color of the components of indicators 52 and 54 may change in order to signal to the pilot that indicators 52 and 54 are no longer providing advanced indications of deviation, but instead are providing current indications of deviation.

FIG. 6A also illustrates one example of a more detailed manner of implementing HSI indicator 62. The illustrated HSI 62 provides a conventional compass rose 64 in the center of which is provided an aircraft icon 66 illustrating the current heading and track of the aircraft with respect to the surrounding compass rose 64. HSI 62 may be displayed on PFD 12 at all times during normal flight conditions. Horizontal situation indicator 62 further includes a course deviation indicator (CDI) that illustrates the amount of deviation of the aircraft from its current course. The course deviation indicator includes a course deviation line 70 and a series of tick marks 72 representing the course deviation scale. The amount of distance represented by each tick mark 72 may be varied depending upon current flight conditions and/or may be varied based upon pilot input. The number of tick marks 72 at which course deviation line 70 is positioned from aircraft icon 66 at the center of HSI 62 indicates the amount of horizontal deviation of the aircraft from its current course.

The horizontal deviation represented by course deviation line 70 is the amount of horizontal deviation of the aircraft's current position with respect to the currently active leg of the flight plan. That is, the horizontal deviation line 70 does not provide a preview of the horizontal deviation with respect to the next flight plan leg after the currently active leg. Thus, in the situation illustrated in FIG. 6A, horizontal deviation indicator 62 provides an indication of the aircraft's current horizontal deviation from final approach segment 56, while course deviation line 70 provides an indication of the aircraft's current horizontal deviation from the pre-final approach segment 60. The pre-final approach leg 60 in FIG. 6A, which is the currently active flight leg, is the leg that leads toward waypoint FENAB. The final approach leg 56 in FIG. 6A, which is not yet active, is the leg that ends at airport 45 (KBIV in the illustrated example of FIG. 6A). The pilot in the situation illustrated in FIG. 6A is therefore provided with horizontal deviation indications with respect to two different legs of the flight plan, thereby providing the pilot with more information to help facilitate the transition between the active pre-final flight leg 60 and the subsequent final approach leg 56.

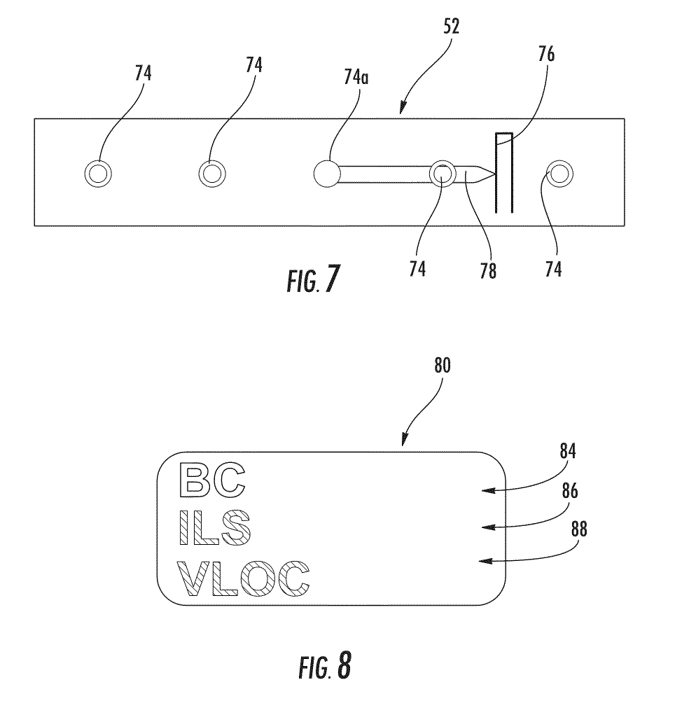

An enlarged view of one illustrative example of a horizontal deviation indicator 52 is shown in FIG. 7. Horizontal deviation indicator 52 includes a series of tick marks 74 that define a horizontal scale. The distance between each tick mark 74 represents a specific distance that may be varied, depending upon any one or more of: pilot setting, flight situation, and PFD manufacturer. A vertical bar 76 is positioned along horizontal deviation indicator 52 at the appropriate position to indicate the aircraft's current horizontal deviation from the corresponding flight path segment. The amount of horizontal deviation is indicated by the distance of vertical bar 76 from center tick mark 74a. Thus, if each tick mark 74 in FIG. 7 represented 2 nautical miles, horizontal deviation indicator 52 of FIG. 7 would be indicating that the aircraft is approximately 3 nautical miles off-course. An arrow 78 indicates in which direction the pilot should fly in order to get back on course. Thus, in the example of FIG. 7, the pilot should turn right to get back on course.

Vertical deviation indicator 54 provides an indication of vertical deviation from a flight path segment in an analogous manner to that of horizontal deviation indicator 52. That is, the vertical deviation indicator 54 includes a series of tick marks wherein the position of a bar relative to a center tick mark represents the current vertical deviation of the aircraft. The main difference between vertical deviation indicator 54 and horizontal deviation indicator 52 is their orientation, with the former being vertically oriented and the latter horizontally oriented.

If the aircraft is currently off course by an amount that exceeds the scale of the tick marks on either horizontal deviation indicator 52 or vertical deviation indicator 54, system 10 may be configured to display either or both indicators 52 and/or 54 in a different manner to indicate that the deviation is beyond the current scale of the indicators 52, 54. In one embodiment, display system 10 may be configured to change the color of deviation indicators 52 and 54 if the deviation is off the scale. Further, in at least one embodiment, display system 10 may be configured to display deviation indicators 52 and/or 54 in a first color when the deviation to a currently active flight plan leg is on scale, a second color when the deviation to a currently active flight plan leg is off scale, a third color when the deviation to a subsequent (but not yet active) flight plan leg is on scale, and a fourth color when the deviation to a subsequent (but not yet active) flight plan leg is off scale. The choice of colors may vary. In one embodiment, the first color may be green, the second color may be yellow, the third color may be white, and the fourth color may be gray. Display system 10 is configured to automatically change these colors based upon the movement of the aircraft and/or in response to pilot changes to the flight plan legs.

It will be understood by those skilled in the art that in at least some situations, vertical deviation indicators 54 may not appear on PFD 12. For example, if a pilot is flying a non-precision approach in which the airport's local navigation source does not provide vertical-deviation signals, PFD 12 may omit vertical deviation indicators 54 while only displaying horizontal deviation indicators 52.

Display system 10 may be configured to declutter PFD 12 by not showing horizontal and vertical deviation indicators 52 and 54 at times when the aircraft is not within a predetermined range of an airport which has been loaded into an active flight plan as the destination airport. The predetermined range may take on a variety of different values. In one embodiment, the predetermined range may be approximately 30 nautical miles. In such an embodiment, display system 10 is configured to automatically display horizontal and vertical (if applicable) deviation indicators 52 and 54 whenever the aircraft is within 30 nautical miles of the destination airport, as determined by the active flight plan. In some embodiments, this predetermined range may be pilot adjustable. Display system 10 may also be configured, or alternatively be configured, to automatically display deviation indicators 52 and/or 54 in response to other events such as, but not limited to, the activation of a vector-to-final procedure.

When display system 10 first displays horizontal and vertical deviation indicators 52 and 54, it may automatically display thereon the horizontal and vertical deviations of the aircraft's current position with respect to the final approach 56 for the aircraft. That is, from the moment indicators 52 and 54 appear on PFD 12, they may be displayed so as to define the aircraft's current deviations from the final approach 56, regardless of whether the final approach 56 is or is not yet the currently active segment of the flight plan. Further, in some embodiments, PFD 12 may be configured to allow a pilot to toggle between displaying deviation indicators 52, 54 with respect to the final approach leg and with respect to the currently active flight plan leg, to the extent those legs are different. In other embodiments, no such toggling is possible.

As was noted above, display system 10 may be configured to change the manner in which horizontal and vertical deviation indicators 52 and 54 are displayed when the aircraft transitions between the pre-final approach leg and the final approach leg 56. In carrying out this change, display system 10 may rely upon information from an autopilot system, or it may act without input from an autopilot system. In one embodiment, display system 10 may alter the display of indicators 52 and 54 when the autopilot system captures the final approach vector. In other embodiments, display system 10 may delay altering the display until the aircraft reaches the final approach fix 56, or approaches within a specified range of the final approach fix. In still other embodiments, display system 10 may use other criteria for changing the appearance of deviation indicators 52 and 54. Regardless of the specific manner and/or criteria used by display system 10 to alter the appearance of indicators 52 and 54, display system 10 is, in at least one embodiment, configured to make this alteration in appearance automatically; that is, without any direct instructions or controls being provided or manipulated by the pilot.

In the example illustrated in FIGS. 6A and 6B, the pre-final approach leg 60 is the flight plan leg leading to the final approach fix 58 bearing the identifier FENAB. In other embodiments, it will be understood that the pre-final approach leg 60 may be any other type of flight plan leg that precedes the final approach. Thus, in some situations, the pre-final approach leg 60 may be a base leg of an airport traffic pattern, or an intermediate approach leg, or a leg leading to the initial approach fix, or any other type of flight plan leg that precedes the final approach leg.

As shown in FIGS. 5A and 6A, PFD 12 may be constructed to display an approach annunciator 80 at, or substantially near, the same time that it displays horizontal and vertical deviation indicators 52 and 54. Approach annunciator 80, in the illustrated embodiment, identifies the type of approach and the navigation source for the approach. The approach types may be divided into two general categories: those that use the VLOC radios, and those that use the GPS/WAAS receivers. Approach types in the former category includes the following: ILS (Instrument Landing System; localizer and glideslope); LOC (Localizer; uses the horizontal deviation indicator only); LOCBC (Localizer Back Course; uses the horizontal deviation indicator only); VOR (VHF Omni Radio; uses the horizontal deviation indicator only); LDA (Localizer Type Directional Aid Approach; uses the horizontal deviation indicator only); and SDF (Simplified Directional Facility; uses the horizontal deviation indicator only). Approach types in the latter category include the following: LP (Localizer Performance without vertical guidance; uses the horizontal deviation indicator only); LPV (Localizer Performance with Vertical Guidance; LNAV (Lateral Navigation; uses the horizontal deviation indicator only); LNAV+V (Lateral Navigation plus advsor-only Vertical guidance); and LNAV/VNAV (Lateral Navigation/Vertical Navigation). Additional types of approaches may also be identified in approach annunciator 80, and PFD 12 may use any suitable abbreviation to provide such annuciations to the pilot.

The source of navigation identified in the approach annuciator 80 may be GPS (Approach Mode) or VLOC (Localizer Tuned). It will be understood that the source of navigation identified in approach annunciator 80 refers to the source of navigation for the final approach 56. Thus, if the final approach 56 is not yet the active leg of the flight plan, the aircraft may be utilizing a navigation source that is different from the navigation source identified in annunciator 80. PFD 12, in the illustrated embodiment, identifies the current navigation source in a separate annunciation box 82 (FIGS. 6A and 9A). As shown in the example of FIG. 6A, both the current source of navigation (box 82) and the approach navigation source (annunciator 80) are GPS. As shown in the example of FIG. 9A, the current source of navigation (box 82) is GPS while the approach source of navigation (annunciator 80) is ILS.

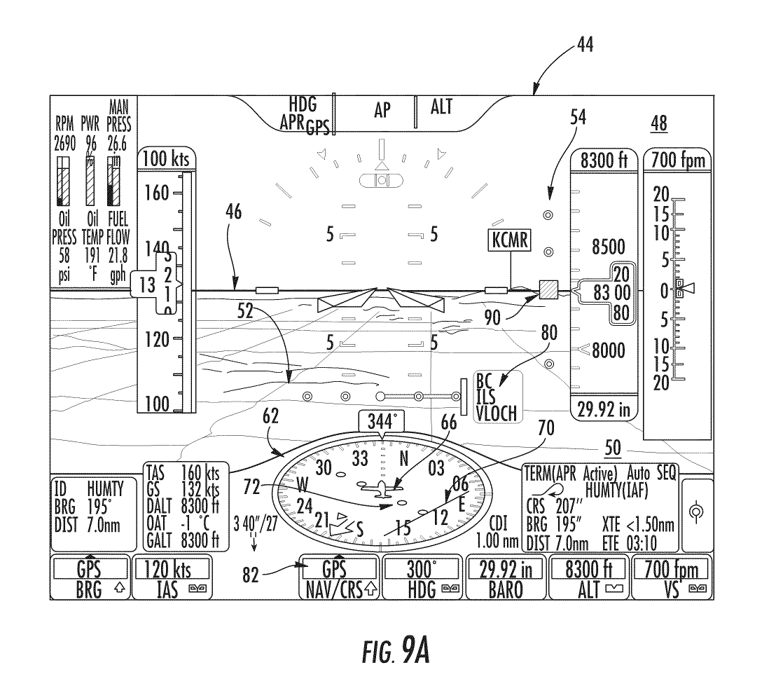

FIG. 8 illustrates an example of approach annunciator 80. Approach annunciator 80 includes a top line 84, a middle line 86, and a bottom line 88. The information displayed on each of the lines 84, 86, and/or 88 may be varied from that illustrated herein, including the content, abbreviations, location, and/or format. Approach annunicator 80 may be displayed such that it appears on PFD 12 in a semi-transparent fashion, thereby allowing artificial horizon line 46 and/or any features on terrain portion 50 of PFD 12 to at least partially be seen through approach annunciator 80.

Top line 84 identifies if the approach is a back course or a reverse course. If the approach is neither of these, top line 84 is left blank. Top line 84 includes the abbreviation BC if the pilot is navigating to a localizer but is currently flying a back course (the angle between the front course to the localizer and the aircraft's heading is greater than 105 degrees). Top line 84 includes the abbreviation REV if the pilot is currently navigating to a GPS final approach segment in a preview mode, but the pilot is currently flying a reverse course (the angle between the GPS front course to the airport and the aircraft's heading is greater than 105 degrees). Other information may be included in top line 84, and/or top line 84 may be omitted in some embodiments.

Middle line 86 identifies the type of approach. An example of the abbreviations that may be used in middle line 86 was previously provided above. Other types of abbreviations and/or other manners of indicating the type of approach may be used.

Bottom line 88 identifies the navigation source for the approach. An example of the abbreviations that may be used with bottom line 88 was previously provided above. Other types of abbreviations and/or other manners of indicating the navigation source may be used.

Controller 16, or any other suitable controller, causes PFD 12 to display approach annunciator 80 automatically without requiring any activation or manipulation of controls by the pilot. The pilot does not need to look up the type of approach from the flight plan, nor does the pilot need to look up the source of navigation from the flight plan. Rather, controller 16, or other suitable controller 16, automatically retrieves this information from the stored flight plan and displays it in approach annunciator 80. Approach annunciator 80, as noted above, may be automatically displayed prior to the final approach segment 56 becoming the active flight plan segment.

FIGS. 9A and 9B illustrate another example of a PFD screen shot 44 and an MFD screenshot 36, respectively, that may appear on PFD 12 and MFD 14 of display system 10 during an aircraft's back course procedure to an initial approach fix HUMTY. The approach is for the Ernest P. Love airfield in Prescott, Ariz., runway 21L. The autopilot has been engaged in these screen shots with both the lateral and vertical modes active, although it will be understood that the advanced display of lateral and vertical deviation indicators 52 and 54 is not incumbent upon any autopilot mode being activated.

As with FIGS. 6A and 6B, screen shots 36 and 44 of FIGS. 9A and 9B display information corresponding to substantially the same moment in time. That is, a pilot looking at MFD screen shot 36 of FIG. 9B would see, at that moment, on his or her corresponding PFD a screen shot substantially like that shown in screen shot 44 of FIG. 9A, and vice versa. Of course, as would be understood by those skilled in the art, the layout of PFD screen shot 44 can be varied substantially from that shown in FIG. 9A, and the use of an MFD can be omitted, in some embodiments, in its entirety. Indeed, MFD screen shots 36 in FIGS. 6B and 9B have been included herein merely to provide geographic reference information about the aircraft's current position and heading relative to the flight plan for better understanding the content of PFD screen shots 44.

PFD screen shot 44 of FIG. 9A includes a striped symbol 90 positioned in the center of vertical deviation indicator 54. Striped symbol 90 indicates that the vertical navigation source for the approach is not available to the aircraft in light of the aircraft's current position. PFD screen shot 44 of FIG. 9A further indicates, via approach annunciator 80, that the approach involves flying a back course (abbreviation BC), it is an ILS approach, and the navigation source for the approach is VLOC1. Still further PFD screen shot 44 indicates via annunciation box 82 that the current source of navigation is GPS. The horizontal arrow 78 of horizontal deviation indicator 52 in FIG. 9A provides an advanced indication that the aircraft needs to turn right to get on course for the final approach. That is, horizontal deviation indicator 52 of FIG. 9A is providing a horizontal deviation indication with respect to the final approach, not the currently active flight plan segment. MFD screen shot 36 of FIG. 9B provides a map representation of the final approach 56 and the pre-final approach 60 (which is the currently active flight plan leg).

The various embodiments of the present invention provide advance information to the pilot regarding the aircraft's position relative to the final approach. The advance information may be provided in the same manner for all different types of approaches, i.e. indicators 52 and 54 may be located in the same position with the same color indications regardless of the type of final approach. Further, the position of indicators 52 and 54 does not change depending upon whether these indicators are providing advanced indications to the not-yet-active final approach leg 56, or current indications to the active final approach leg 56. This enables the pilot to see the advanced deviations in the same manner and format that he or she sees the non-advanced deviations, thereby reducing any mental effort that would otherwise be required if the advanced deviations were provided in different format or location from the non-advanced deviations. In other words, the pilot does not have to look elsewhere, or convert from a different information format, in order to see and understand the advanced deviations provided by indicators 52 and 54. Instead, the advanced deviations are provided in the same location and with the same format as the non-advanced deviations, thereby making it easier for the pilot to understand them.

While the present invention has been described herein in terms of various embodiments, it should be understood that the invention is not limited to these particular embodiments, nor to the embodiments and layouts depicted in the attached drawings.

What is claimed is:

1. An aircraft cockpit display system comprising:
a primary flight display;
a navigation system adapted to determine a current position and heading of the aircraft;
a memory adapted to store information relating to a final approach leg and a pre-final approach leg of an aircraft flight plan; and
a controller in communication with said navigation system and said memory, said controller adapted to cause said primary flight display to display a horizontal situation indicator (HSI) at a first location on said primary flight display and horizontal deviation indicators at a second location on said primary flight display, said horizontal deviation indicators providing an indication of the aircraft's current position with respect to the final approach leg when the pre-final approach leg is an active leg of the aircraft flight plan.

2. The system of claim 1 wherein the controller is further adapted to cause said primary flight display to display vertical deviation indicators with respect to the final approach when the pre-final approach leg is an active leg of the aircraft flight plan.

3. The system of claim 2 wherein said controller is further adapted to automatically display both the horizontal deviation indicators and the vertical deviation indicators if the aircraft is within a predetermined range of the runway or the runway's corresponding airport.

4. The system of claim 1 wherein said HSI provides a horizontal course deviation indication relative to the pre-final approach leg when said pre-final approach leg is an active leg of the aircraft flight plan.

5. The system of claim 1 wherein said controller automatically changes the display of the horizontal deviation indicators from the final approach when the aircraft transitions from the pre-final approach leg to the final approach leg.

6. The system of claim 1 wherein said primary flight display displays an approach annunciator, said approach annunciator indicating a type of approach to the runway and a navigation source to be used for the approach to the runway, said primary flight display displaying said approach annunciator prior to said final approach becoming an active leg of the flight plan.

7. The system of claim 6 wherein said primary flight display annunciates a current source of navigation that may be different from the navigation source indicated in said approach annunciator.

8. The system of claim 1 wherein said horizontal deviation indicators are displayed in a first color while the pre-final approach leg is an active leg of the aircraft flight plan, and a second color after a final approach vector has been captured by the aircraft, said second color being different from said first color.

9. The system of claim 1 wherein said controller is further adapted to automatically display the horizontal deviation indicators if the aircraft is within a predetermined range of the runway or the runway's corresponding airport.

10. An aircraft cockpit display system comprising;
a primary flight display (PFD);
a navigation system adapted to determine a current position and heading of the aircraft;
a memory adapted to store information relating to an approach vector for a runway; and
a controller in communication with said navigation system and said memory, said controller adapted to cause said primary flight display to display horizontal deviation indicators indicating a horizontal deviation of the aircraft's current position from said approach vector prior to said aircraft capturing said approach vector, said controller automatically displaying said horizontal deviation indicators without requiring a pilot to manipulate any controls on said primary flight display.

11. The system of claim 10 wherein said controller is further adapted to cause said primary flight display to display vertical deviation indicators indicating a vertical deviation of the aircraft's current position from said approach vector prior to said aircraft capturing said approach vector.

12. The system of claim 10 wherein said approach vector is a final approach vector.

13. The system of claim 10 wherein said approach vector is an initial approach vector.

14. The system of claim 11 wherein said horizontal and vertical deviation indicators are displayed in different manners prior to the aircraft capturing said approach vector and after the aircraft captures the approach vector.

15. The system of claim 14 wherein said different manner includes changing a color of said horizontal and vertical deviation indicators.

16. The system of claim 10 further including an autopilot system that determines whether the aircraft has captured the approach vector.

17. The system of claim 16 wherein said autopilot system includes an approach that may be armed prior to the aircraft switching from an en route navigation source to an approach navigation source.

18. A method of displaying information on a primary flight display (PFD) of an aircraft cockpit comprising:
determining when a flight plan leg prior to a final approach, leg is an activeleg of an aircraft flight plan;
displaying in a first location on said PFD a horizontal situation indicator (HSI) indicating a deviation of the aircraft's current position with respect to said flight plan leg prior to a final approach leg; and
displaying in a second location on said PFD at least one of horizontal and vertical deviation indicators, while said flight plan leg prior to the final approach leg is an active leg, that indicate at least one of the aircraft's current horizontal and vertical deviations from the final approach leg.

19. The method of claim 18 further including displaying, while said flight plan leg prior to the final leg is an active leg, both horizontal and vertical deviation indicators on said PFD that indicate the aircraft's current horizontal and vertical deviations from the final approach leg.

20. The method of claim 18 further including automatically changing a color of said horizontal and vertical deviation indicators when the approach leg becomes the active flight plan leg.

21. The method of claim 18 further including displaying on said PFD both a current navigation source and a navigation source for use with said approach leg.

22. The method of claim 19 further including:
displaying an approach annunciator on said PFD prior to the final leg becoming an active leg, said approach annunciator indicating a type of approach to the runway and a navigation source to be used for the approach to the runway; and
displaying a current source of navigation wherein said current source of navigation may be different from the navigation source indicated in said approach annunciator.

23. A method of displaying information on a primary flight display (PFD) of an aircraft cockpit comprising:
determining a current position of an aircraft; and
automatically displaying on said PFD, without requiring a pilot to manipulate any controls on said PFD, at least a horizontal deviation indicator from a final approach prior to the final approach becoming an active segment of a flight plan for the aircraft.

24. The method of claim 23 further including displaying a vertical deviation indicator from the final approach on the PFD prior to the final approach becoming the active segment of the aircraft's flight plan.

25. The method of claim 23 further including displaying a course deviation indicator indicating the horizontal deviation of the aircraft from the current leg of the aircraft's flight plan, said course deviation indicator being displayed separately from said horizontal deviation indicator.

26. The method of claim 23 further including:
displaying an approach annunciator on said PFD prior to the final approach becoming an active segment of the flight plan for the aircraft, said approach annunciator indicating a type of approach to the runway and a navigation source to be used for the approach to the runway; and
displaying a current source of navigation wherein said current source of navigation may be different from the navigation source indicated in said approach annunciator.

27. The system of claim 26 wherein said horizontal deviation indicators are displayed in different colors prior to the final approach becoming an active segment of the flight plan for the aircraft and after the final approach becomes the active segment of the flight plan.

28. An aircraft cockpit display system comprising:
a primary flight display (PFD);
a navigation system adapted to determine a current position and heading of the aircraft;
a memory adapted to store information relating to an approach for a runway; and
a controller in communication with said navigation system and said memory, said controller adapted to cause said primary flight display to display an approach annunciator indicating a type of said approach and a navigation source for said approach, said controller further adapted to automatically display said approach annunciator prior to the final approach becoming an active leg of the flightplan and without requiring any pilot manipulation of any controls of said primary flight display.
